(19) United States
(12) Patent Application Publication
(10) Pub. No.: US 2005/0082734 A1
(43) Pub. Date: Apr. 21, 2005

(54) Sheet processing system

(75) Inventors: Tatsuya Goto, Chiba (JP); Akihiro Sato, Kanagawa (JP); Akihiro Shimizu, Chiba (JP); Katsuaki Hirai, Ibaraki (JP); Hideki Kushida, Ibaraki (JP); Tomokazu Nakamura, Chiba (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/963,587

(22) Filed: Oct. 14, 2004

(30) Foreign Application Priority Data
Oct. 16, 2003 (JP) 2003-356737

(51) Int. Cl. B41F 1/00; B41J 1/00; B65H 5/00; B41B 1/00; G06K 1/00; G06F 15/00

(52) U.S. Cl. 271/1

(57) ABSTRACT

In a sheet processing system capable of executing plural jobs in parallel, each job being actuated by one of the sheet processing units or by a combination of plural sheet processing units (printer and a sheet stacking unit, an inserter and a finisher), when a detection sensor detects that a cover is open, a CPU circuit section executes stop control for a job using a horizontal conveying path and pairs of conveying rollers accessible through an opening in the cover and other job not using a portion accessible through the opening in the cover.

### BACKGROUND OF THE INVENTION

1. Field of the Invention

The present invention relates to a sheet processing system and more particularly to a sheet processing system capable of executing plural jobs in parallel under conditions in which plural sheet processing units each having sheet processing function are combined.

2. Description of the Related Art

Conventionally, there have been proposed image forming systems which are capable of performing various kinds of post-processings desired by a user such as bundle discharging, binding, folding, bookbinding under conditions in which a sheet post-processing unit such as a finisher and folding unit is connected to an image forming unit such a copier. To enable all sheet post-processings which the user needs, such as the bundle discharging, binding, folding and bookbinding to be achieved in a single system, plural sheet post-processing units each performing its specialized post-processing are connected to an image forming unit.

For example, Japanese Patent Application Laid-Open (JP-A) No. 2003-89473 has disclosed an image forming system in which plural sheet post-processing units are connected to the image forming unit. FIG. 19 is a schematic sectional view showing schematically an example of a conventional image forming system. The image forming system B shown in FIG. 19 comprises an image forming unit 1000 including an original document feeding unit 1100, an image reader 1200, and a printer 1300, a buffer module 1400, a folding unit 1500 and a finisher 1600.

However, in the image forming system B, while sheets are being conveyed from the printer 1300 to the buffer module 1400 for some job, the folding unit 1500 and the finisher 1600 cannot be used and need to stand by until the aforementioned job is finished. As a result, the availability of the entire system drops considerably.

The above-described respective units have opening/closing members such as doors for covering their mechanical portions. After an image is formed, sheets undergo post-processings in the folding unit 1500 and the finisher 1600 and if the front door is opened for maintenance of the printer 1300 when those jobs are not finished, the entire system is stopped. For the reason, the maintenance cannot be started until a job ends, because the entire system is stopped if the door is opened for that maintenance and therefore, there is generated a wasteful waiting time.

### SUMMARY OF THE INVENTION

An object of the present invention is to provide a sheet processing system having a high productivity.

Another object of the present invention is to provide a sheet processing system which enables part of the opening/closing members to be opened/closed even if a job is not finished.

Still another object of the present invention is to provide a sheet processing system capable of executing plural jobs in parallel, the sheet processing system restricting the opening/closing action of the opening/closing members in a sheet processing unit used for a job and enabling the opening/closing member in a sheet processing unit not used for a job to be opened/closed.

To achieve the above object, the present invention provides a sheet processing system which includes plural sheet processing units each having sheet processing function, and which is capable of executing plural jobs of sheet processing in parallel, each job being actuated by one of the sheet processing units or by a combination of plural sheet processing units, the sheet processing system comprising: opening/closing members provided on each of the sheet processing units to be accessible to the interior of the sheet processing unit; sensors which detect the opening/closing state of the opening/closing member; and a controller which controls a stop of the sheet processing unit according to a signal from the sensor, wherein the controller carries out stop control for each of the jobs to be executed in parallel according to the result of a detection by the sensor independently.

Consequently, the present invention can provide a sheet processing system ensuring a high productivity.

The sheet processing function (unit) mentioned here refers to a function which undergoes some processing on a sheet, for example, image forming function (unit) for forming an image on a sheet, sheet stacking function (unit) for stacking sheets, insert function (unit) for inserting a front page, tab or the like, a stapling function (unit) for arranging and bundling sheets. Further the job mentioned here refers to a sequence of sheet processings when one or plural processings are executed on a sheet. Accessible to the interior mentioned here means that an operator can access a photosensitive body or developing means in an image forming unit, a conveying path or a conveying roller in a sheet stacking unit for jamming processing or maintenance.

### BRIEF DESCRIPTION OF THE DRAWINGS

FIG. 1 is a longitudinally sectional view showing the structure of major components of the sheet processing system according to a first embodiment of the present invention;

FIG. 2 is a block diagram showing the structure of the controller for controlling the entire sheet processing system shown in FIG. 1;

FIG. 3 is a longitudinally sectional view showing the schematic structure of a sheet stacking unit 500, an inserter 600, and a finisher 700 which constitute the sheet processing system of the first embodiment of the present invention;

FIG. 4 is a block diagram showing the structure of a sheet stacking unit control section 501 for controlling the driving of a sheet stacking unit 500 of the first embodiment;

FIG. 5 is a block diagram showing the structure of an inserter control section 601 for controlling the driving of the inserter 600 of the first embodiment;

FIG. 6 is a block diagram showing the structure of a finisher control section 701 for controlling the driving of the finisher 700 of the first embodiment;

FIG. 7 is a schematic view showing the arrangement of covers in the sheet processing system of the embodiment of the present invention;

FIG. 8 is a schematic sectional view showing schematically sheet processing action which the sheet processing system of the embodiment performs;

FIG. 9 is a schematic sectional view showing schematically sheet processing action which the sheet processing system of the embodiment performs;

FIG. 10 is a perspective view showing schematically a condition in which part of the cover of the sheet processing system is opened;

FIG. 11 is a perspective view showing schematically partition walls of the embodiment for explaining the walls;

FIG. 12 is a diagram showing a window in the display section of the embodiment;

FIG. 13 is a diagram showing a window in the display section of the first embodiment;

FIG. 14 is a diagram showing a window in the display section of the first embodiment;

FIG. 15 is a diagram showing a window in the display section of the first embodiment;

FIG. 16 is a schematic view of the interior of the unit for explaining the lock mechanism of the first embodiment;

FIG. 17 is a flow chart for explaining the operation of the system when the cover is opened/closed when the job concerning the first embodiment is being carried out;

FIG. 18 is a flow chart for explaining the operation of the lock mechanism of a second embodiment; and

FIG. 19 is a longitudinally sectional view showing schematically a conventional image forming system.

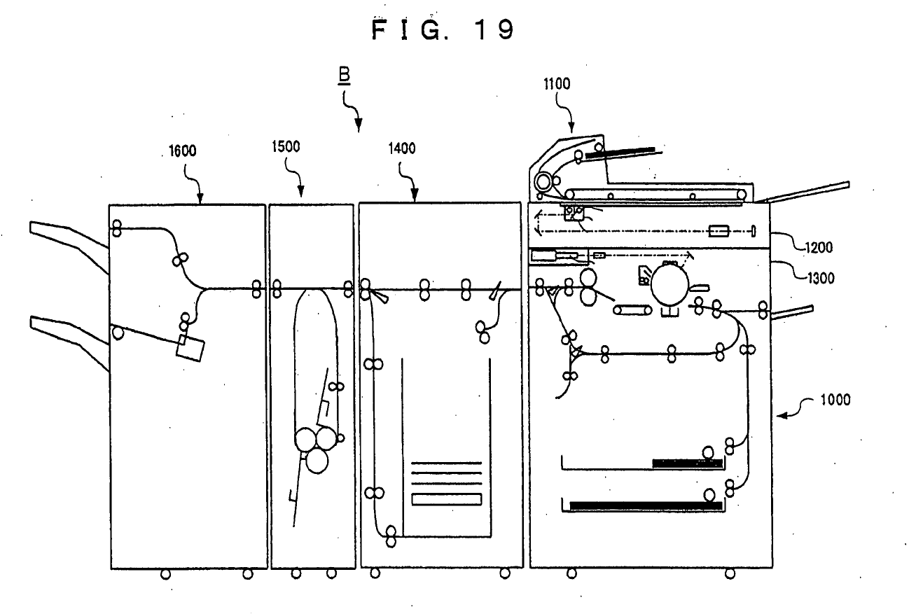

### DETAIELD DESCRIPTION OF THE PREFERRED EMBODIMENTS

Hereinafter, the best modes of the present invention will be described in detail with reference to the embodiments and the accompanying drawings. The dimensions, material, shape and relative disposition of components noted in this embodiment do not restrict the scope of the present invention unless there is any particular description thereabout. The material, shape and the like of a member stated previously is the same as those described first unless described otherwise.

First Embodiment

(Outline of Sheet Processing System)

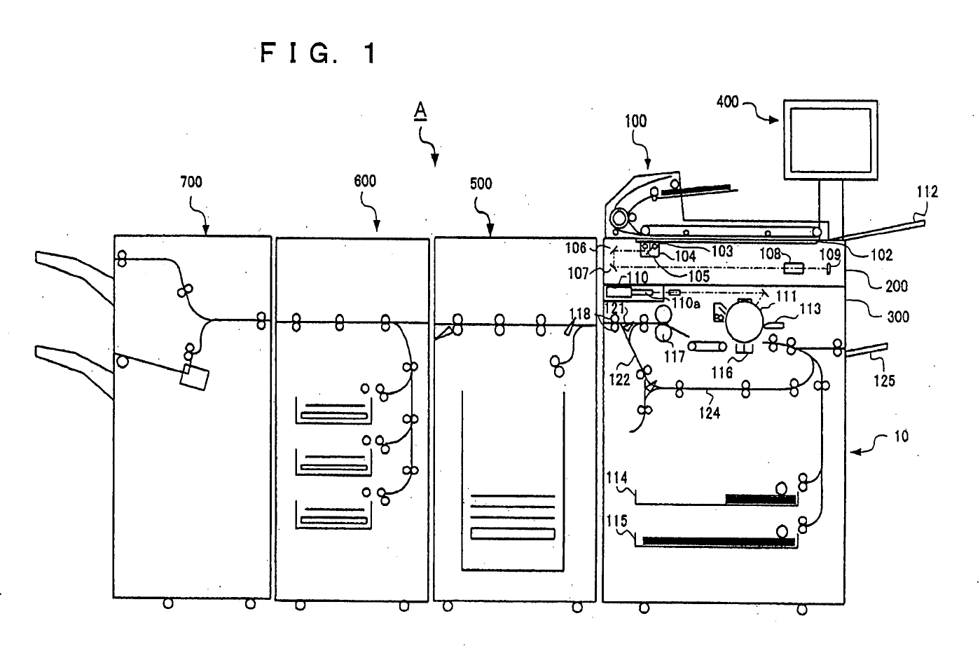

FIG. 1 is a longitudinally sectional view showing the structure of major components of the sheet processing system of a first embodiment of the present invention.

As shown in FIG. 1, the sheet processing system A comprises an image forming unit 10, a sheet stacking unit 500, an inserter 600 and a finisher 700 each having different sheet processing function, those units being connected in series successively in order indicated in the same figure.

(Image Forming Unit)

The image forming unit 10 comprises a printer 300, an image reader 200 for reading an image on an original document loaded on the top of the printer 300, an original document feeding unit 100 which is installed on the top face of the image reader 200 such that it can be opened/closed and feeds an original document and a operation display unit 400 provided above the image reader 200.

The original document feeding unit 100 separates plural original documents set on an original document tray directing upward one by one successively from a beginning page and carries to an original document image reading position on the image reader 200 through a curved path and the image reader 200 reads. After the image is read by the image reader, that original document is discharged to a discharge tray 112 provided on the right end of the original document feeding unit 100.

An image reader 200 has a platen glass 102 on its top face and a scanner unit 104 for reading an original document conveyed to the original document image reading position on the platen glass 102 from the original document feeding unit 100 is provided below the platen glass 102.

By conveying the original document so that it passes the reading position from the left to the right, scanning for reading the original document is carried out with a direction perpendicular to the original document conveying direction as main scanning direction and the conveying direction as an sub-scanning direction. That is, when the original document passes the reading position, the original document is read by each line along the main scanning direction by the image sensor 109 while the original document is conveyed in the auxiliary scanning direction so as to read the entire original document. An image read optically is converted to image data by the image sensor 109 and outputted. Image data outputted from the image sensor 109 undergoes a predetermined processing by an image signal control section 202 described later and after that, is inputted to an exposure control section 110 of the printer 300 as video signal.

It is possible to convey an original document onto the platen glass 102 by means of the original document feeding unit 100 and stop at a predetermined position and read the original document by scanning from the left to the right using the scanner unit 104. This reading method is called original document fixed reading.

When the original document is read without use of the original document feeding unit 100, first, the original document feeding unit 100 is lifted up by the user and an original document is placed on the platen glass 102 and then, the original document is read by scanning from the left to the right with the scanner unit 104. That is, when reading the original document without use of the original document feeding unit 100, the original document fixed reading method is used.

The printer 300 comprises the exposure control section 110 which modulates laser beam based on a video signal inputted and outputs, a polygon mirror 110a for scanning by irradiating a photosensitive drum 111 with laser beam, a photosensitive drum 111 in which an electrostatic latent image is formed corresponding to the irradiated laser beam for scanning, and a developer unit 113 for developing the electrostatic latent image with developer.

At a timing synchronous with a start of laser beam irradiation, a sheet S is fed from respective cassettes 114, 115, a manual feeding section 125 or a double-side conveying path 124, which are provided in the printer 300 and conveyed between the photosensitive drum 111 and a transfer section 116. An image of the developer formed on the photosensitive drum 111 is transferred to the sheet S conveyed by the transfer section 116.

After the image of the developer is transferred, the sheet S is conveyed to a fixing section 117, where the sheet S is thermally pressed so that the developer is fixed on the sheet S. After passing the fixing section 117, the sheet S passes a flapper 121 and a discharge roller 118 and then is discharged out of the printer 300 (to the sheet stacking unit 500).

When the sheet S is discharged with its image forming face directed downward, the sheet S is introduced into an inversion path 122 temporarily after it passes the fixing section 117 by switching operation of the flapper 121. After the rear end of the sheet S passes the flapper 121, the sheet S is switched back and discharged from the printer 300 through the discharge roller 118. Hereinafter, this discharge style is called inverted discharge. This inverted discharge is executed when images are formed in order from the head page for example, when forming an image after read by means of the original document feeding unit 100 or when forming an image after outputted from the computer and the order of the sheets after discharged is an order in a proper sequence.

When an image is formed on a hard sheet S, such as OHP sheet, conveyed from the manual feeding section 125, the sheet S is discharged by means of the discharge roller 118 such that its image forming face is directed upward without being introduced into the inversion path 122.

When double-side recording for forming images on both side faces of the sheet is set up, the sheet S is introduced into the inversion path 122 by switching operation of the flapper 121 and after that, conveyed to the double-side conveying path 124. The sheet S introduced to the double-side conveying path 124 is conveyed in again between the photosensitive drum 111 and the transfer section 116 at the aforementioned timing.

A sheet discharged from the printer 300 is conveyed to the sheet stacking unit 500. This sheet stacking unit 500 stacks the sheets. In other cases, after discharged from the printer 300, the sheet S passes the sheet stacking unit 500 and the inserter 600, which is one kind of a sheet feeding unit and is sent to the finisher 700.

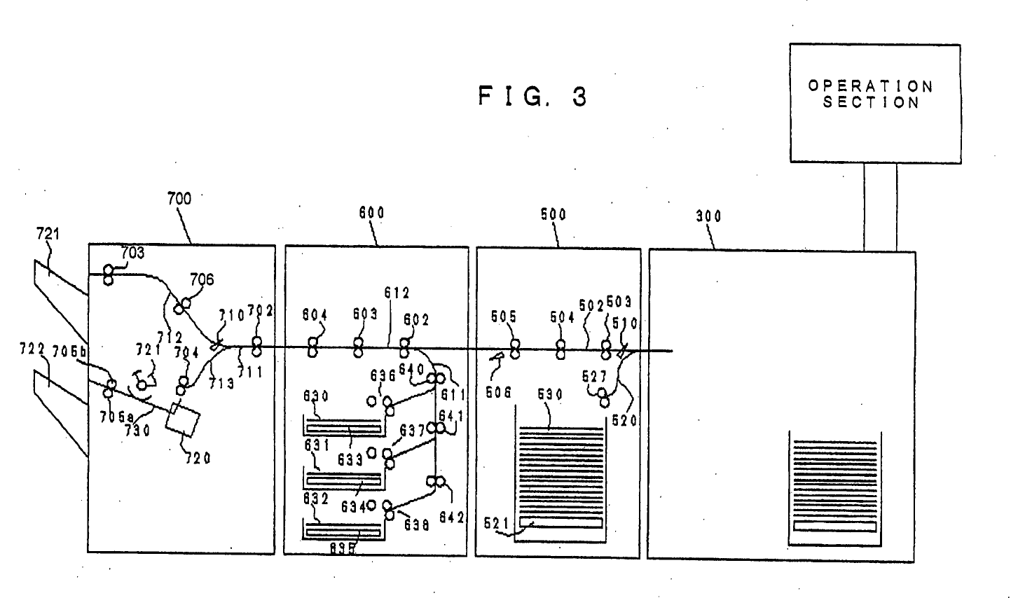

Hereinafter, the configuration of the sheet stacking unit 500, the inserter 600 and the finisher 700 will be described with reference to FIG. 3. FIG. 3 is a longitudinally sectional view showing the schematic configuration of the sheet stacking unit 500, the inserter 600 and the finisher 700, which constitute the sheet processing system according to the embodiment.

(Schematic Configuration of Sheet Stacking Unit)

The sheet stacking unit 500 is capable of stacking a large number of the sheets S outputted from the printer 300. As shown in FIG. 3, the sheet stacking unit 500 comprises a horizontal conveying path 502 for introducing a sheet discharged from the printer 300 to the inserter 600 and the finisher 700, pairs of conveying rollers 503, 504, 505 provided on the horizontal conveying path 502 for conveying the sheet S, a first flapper 510 and a second flapper 506 provided at an intake section (on the side of the printer 300) and at an outlet section (on the side of the finisher 700), respectively, a sheet stacking section 530 capable of storing the sheets S discharged from the printer 300, and a path 520 for introducing the sheet S discharged from the printer 300 to the sheet stacking section 530.

If such a sheet stacking unit 500 executes sheet stacking processing, the first flapper 510 is turned off so as to intercept a passage of the sheet S to the horizontal conveying path 502, so that the sheet S is introduced to the path 520. The sheets S introduced to the path 520 are stacked on the sheet stacking section 530 successively.

On the other hand, if the stacking of the sheets S onto the sheet stacking section 530 is not carried out, the first flapper 510 is turned on so as to intercept the passage of the sheet S to the path 520. After discharged from the printer 300, the sheet S passes the horizontal conveying path 502 from the printer 300 and after that, is conveyed to the inserter 600 and the finisher 700.

Although not shown, it is permissible to provide separately a path for conveying sheets stored temporarily in the sheet stacking section 530 to the inserter 600 and the finisher 700. In this case, the processing capacity of the printer 300, the inserter 600 and the finisher 700 can be controlled for adjustment.

(Schematic Configuration of Inserter)

The inserter 600 inserts a special sheet (color copy paper or the like) of a front page, tab, and the like on a head page or on a halfway page of sheets outputted from the printer 300. More specifically, as shown in FIG. 3, the inserter 600 comprises a horizontal conveying path 612 for introducing the sheet discharged from the pair of the conveying rollers 505 provided in the sheet stacking unit 500 to the finisher 700, pairs of conveying rollers 602, 603, 604 provided on the horizontal conveying path 612, sheet storage sections 630, 631, 632 for storing special sheets (color copy paper, or the like) for the front page, tab and the like on intermediate plates 633, 634, 635, feeding separating sections 636, 637, 638 for conveying the stored special sheets or the like to the horizontal conveying path 612, a vertical conveying path 611 for introducing the special sheet or the like fed from the sheet storage sections 630, 631, 632 to the horizontal conveying path 612 and pairs of conveying rollers 640, 641, 642 provided on the vertical conveying path 611.

The inserter 600 feeds a special sheet such as a front page, tab paper, or the like corresponding to a user's desire to a sheet S outputted from the printer 300 from the sheet storage sections 630, 631, 632 at a predetermined timing and inserts that special sheet into the sheets S outputted from the printer 300.

(Schematic Configuration of Finisher)

The finisher 700 is a unit for executing sorting, binding, perforating, and the like. As shown in FIG. 3, the finisher 700 comprises a finisher path 711 and a pair of intake rollers 702 for introducing a sheet S outputted from the inserter 600, a non-sort path 712 for conveying the sheet S outputted from the inserter 600 to a sample tray 721 without sorting, a sort path 713 for conveying a sheet outputted from the inserter 600 to a sorting section, a switch flapper 710 for switching between the non-sort path 712 and the sort path 713 selectively, an intermediate tray 730 for executing sorting, binding, and the like, a stapler 720 for binding sheets stacked neatly on the intermediate tray 730, and a stack tray 722 on which sheets are discharged after sorting, binding and the like are performed on the intermediate tray 730.

When the finisher 700 does not perform the sorting processing, switch flapper 710 is turned on so as to intercept a passage of the sheet S to the sort path 713 and the sheet S is introduced to the non-sort path 712. After that, this sheet is discharged to a sample tray 721 through a pair of conveying rollers 706 and a pair of non-sort discharge rollers 703, which are provided on the non-sort path 712.

On the other hand, when the finisher 700 performs the sorting processing, the switch flapper 710 is turned off so as to intercept a passage of the sheet S to the non-sort path 712 and the sheets S are introduced to the sort path 713 and stacked to a bundle on the intermediate tray 730 through the sort discharge roller 704. The sheets S stacked on the intermediate tray 730 undergo alignment, stapling, perforating and the like and after that, are discharged to the stack tray 722 through the discharge rollers 705a, 705b. In the meantime, the stack tray 722 is movable appropriately in the vertical direction.

(Structure of Controller)

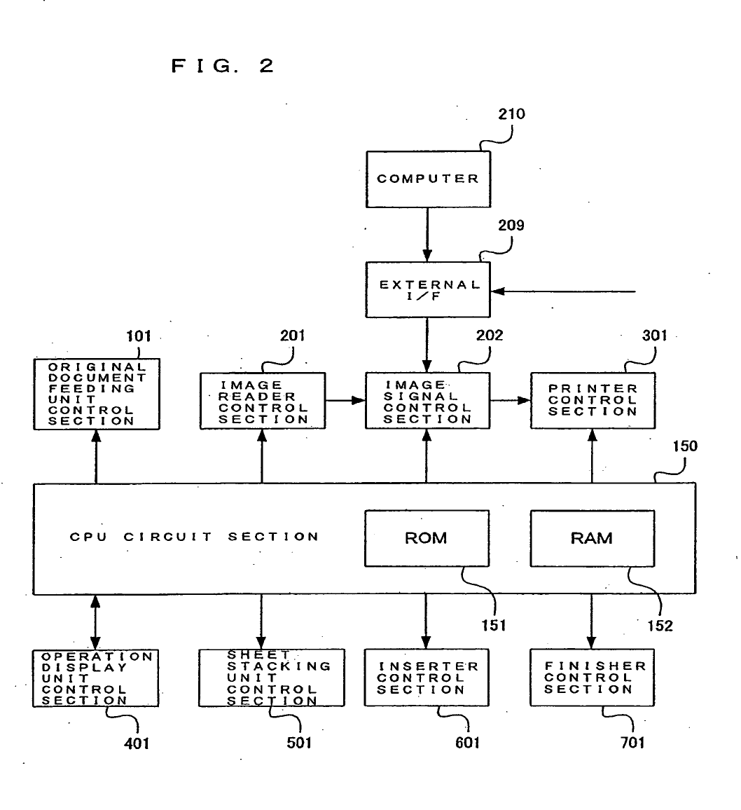

Next, the structure of a controller for controlling the entire sheet processing system of this embodiment will be described with reference to FIG. 2. FIG. 2 is a block diagram showing the structure of the controller for controlling the entire sheet processing system shown in FIG. 1.

As shown in FIG. 2, the controller includes a CPU circuit section 150 and the CPU circuit section 150 contains a CPU (not shown), a ROM 151, and a RAM 152.

The CPU circuit section 150 controls an original document feeding unit control section 101, an image reader control section 201, an image signal control section 202, an external interface 209, a printer control section 301, an operation display unit control section 401, a sheet stacking unit control section 501, a sheet feeding unit control section 601, and a finisher control section 701 synthetically according to control programs stored in the ROM 151.

The RAM 152 holds control data for controlling the respective control sections temporarily and is used as a working region for arithmetic processing accompanied by these controls.

The original document feeding unit control section (hereinafter referred to as original document control section) 101 controls the driving of the original document feeding unit 100 according to instructions from the CPU circuit section 150.

The image reader control section (hereinafter referred to as reader control section) 201 controls the driving of the aforementioned scanner unit 104 and image sensor 109 or the like and transmits an analog image signal outputted from the image sensor 109 to the image signal control section 202.

The image signal control section (hereinafter referred to as image control section) 202 converts analog image signals from the image sensor 109 to digital signals and after that executes the respective processings so as to convert this digital signal to video signal and output to the printer control section 301. Further, the image signal control section executes respective processings on the digital image signal inputted from the computer 210 through the external interface 209 and converts this digital image signal to video signal and output to the printer control section 301. The processing operation of the image control section 202 is controlled by the CPU circuit section 150.

The printer control section 301 drives the exposure control section 110 based on a video signal inputted from the image control section.

The operation display unit control section (hereinafter referred to as display control section) 401 exchanges information between the operation display unit 400 (shown in FIG. 1) and the CPU circuit section 150. As described later, the operation display unit 400 has plural keys for setting respective functions for image formation, a display section for displaying information indicating a setting condition and the like. A key signal corresponding to operation of each key provided on this operation display unit 400 is outputted to the CPU circuit section 150 through the display control section 401. The display control section 401 controls the operation display unit 400 for displaying information corresponding to a signal from the CPU circuit section 150 on the display section of the operation display unit 400.

The sheet stacking unit control section (hereinafter referred to as stacking control section) 501 is loaded on the sheet stacking unit 500 and controls the driving of the sheet stacking unit 500 by exchanging information with the CPU circuit section 150.

The sheet feeding unit control section (hereinafter referred to as inserter control section) 601 is loaded on the inserter 600 and controls the driving of the inserter 600 by exchanging information with the CPU circuit section 150.

The finisher control section 701 is loaded on the finisher 700 and controls the driving of the finisher 700 by exchanging information with the CPU circuit section 150.

Hereinafter the sheet stacking unit control section 501, the inserter control section 601 and the finisher control section 701 will be described in detail.

(Structure of Sheet Stacking Unit Control Section)

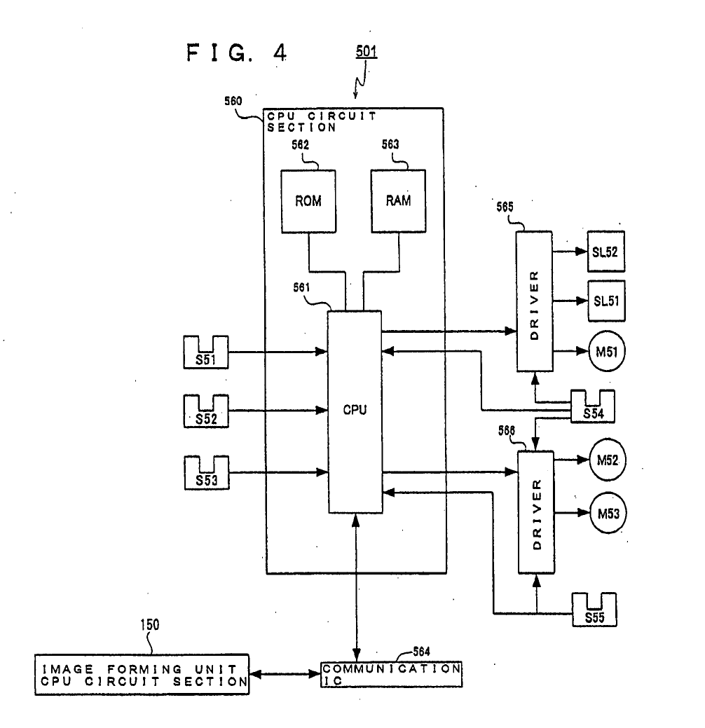

The structure of the sheet stacking unit control section 501 for controlling the driving of the sheet stacking unit 500 will be described with reference to FIG. 4. FIG. 4 is a block diagram showing the structure of the sheet stacking unit control section shown in FIG. 2.

As shown in FIG. 4, the stacking control section 501 has the CPU circuit section 560 which is constituted of a CPU 561, a ROM 562 and a RAM 563. The CPU circuit section 560 communicates with the CPU circuit section 150 provided on the main body side of the image forming unit 10 through a communication IC 564 to exchange data and executes various kinds of programs stored in the ROM 562 according to instructions from the CPU circuit section 150 so as to control the driving of the sheet stacking unit 500.

When this drive control is performed, detection signals from various path sensors S51, S52, S53 provided for detecting a delay or jamming of a sheet being conveyed and detection signals from detection sensors S54, S55 for detecting the opening/closing state of a cover are inputted to the CPU circuit section 560.

Drivers 565, 566 are connected to the CPU circuit section 560. The driver 565 drives a horizontal path conveying motor M51 of a conveying processing module and flapper solenoids SL51, SL52 based on a signal from the CPU 560. The driver 566 drives motors M52, M53 of sheet stacking processing module based on a signal from the CPU circuit section 560.

The conveying processing module includes a horizontal path conveying motor M51 which is a drive source for the pairs of the conveying rollers 503, 504, 505, a flapper solenoid SL51 for switching the first flapper 510 and a flapper solenoid SL52 for switching the second flapper 506. Further the sheet stacking processing module includes a sheet stacking plate motor M52 which is a drive source for a sheet stacking plate 521 and a sheet stacking conveying motor M53 which is a drive source of a conveying roller 527 provided on the path 520.

The detection sensor S54 is a detecting means for detecting the opening/closing state of a cover 551 which will be described later. Then, if it is detected that the cover 551 is opened according to a detection signal from the detection sensor S54, the power supply of the driver 565 is turned off so as to stop the drive of the conveying processing module forcibly. At the same time, the power supply of the driver 566 is turned off so that the drive of the sheet stacking processing module is stopped forcibly.

The detection sensor S55 detects the opening/closing state of a cover 552 described later. If it is detected that the cover 552 is opened according to a detection signal from the detection sensor S55, only the power supply of the driver 566 is turned off, so that the drive of the sheet stacking processing module is stopped forcibly.

(Structure of Inserter Control Section)

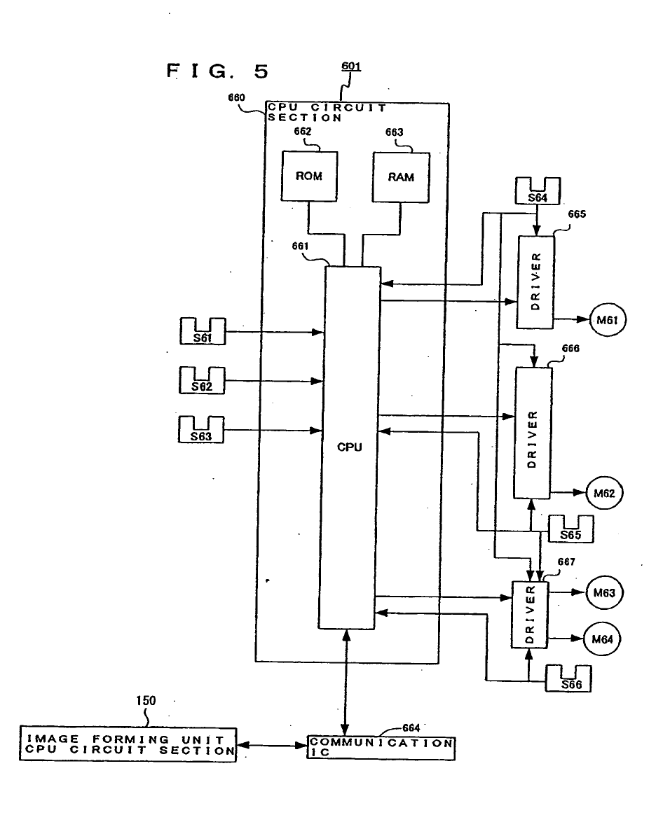

The structure of the inserter control section 601 for controlling the driving of the inserter 600 will be described with reference to FIG. 5. FIG. 5 is a block diagram showing the structure of the inserter control section shown in FIG. 2.

As shown in FIG. 5, the inserter control section 601 has a CPU circuit section 660 which is constituted of a CPU 661, a ROM 662 and a RAM 663. The CPU circuit section 660 communicates with the CPU circuit section 150 provided on the main body side of the image forming unit 10 through a communication IC 664 so as to exchange data and executes various kinds of programs stored in the ROM 662 according to instructions from the CPU circuit section 150 to control the driving of the inserter 600.

When performing this control, detection signals from path sensors S61, S62, S63 and detection signals from detection sensors S64, S65, S66 for detecting the opening/closing state of the cover are inputted to the CPU circuit section 660.

Drivers 665, 666, 667 are connected to the CPU circuit section 660. The driver 665 drives the horizontal path conveying motor M61 of the horizontal conveying processing module based on a signal from the CPU circuit section 660. The driver 666 drives a feeding longitudinal path conveying motor M62 of the vertical conveying processing module based on a signal from the CPU circuit section 660. The driver 667 drives feeding separating section motors M63, M64 of the feeding processing module based on a signal from the CPU circuit section 660.

Here, the horizontal conveying processing module includes a horizontal path conveying motor M61 which is a drive source for the pairs of the conveying rollers 602, 603, 604. Further, the vertical conveying processing module includes a feeding longitudinal path conveying motor M62 which is a drive source for the pairs of the conveying rollers 641, 642, 643. The feeding processing module includes a feeding separating section M63 which is a drive source for feeding separating sections 636, 637, 638 and an intermediate plate lift motor M64 which is a drive source for lifting intermediate plates 633, 634, 635.

The detection sensor S64 is a sensor for detecting the opening/closing state of a cover 651 described later and if it is detected that the cover 651 is open according to a detection signal from the detection sensor S64, the power supply of the driver 665 is turned off and at the same time when the drive of the horizontal conveying processing module is stopped forcibly, the power supply for the drivers 666, 667 is turned off, so that all drives of the inserter 600 are stopped forcibly.

The detection sensor S65 is a sensor for detecting the opening/closing state of a cover 652 described later. If it is detected that the cover 652 is opened according to a detection signal from the detection sensor S65, the power supply of the driver 666 is turned off and at the same time when the drive of the vertical conveying processing module is stopped forcibly, the power supply of the driver 667 is turned off so that the drive of the feeding processing module is stopped forcibly.

The detection sensor S66 is a sensor for detecting the opening/closing state of a cover 653 described later. If it is detected that the cover 653 is opened according to a detection signal from the detection sensor S65, only the power supply of the driver 667 is turned off, so that the drive of the feeding processing module is stopped forcibly.

(Structure of Finisher Control Section)

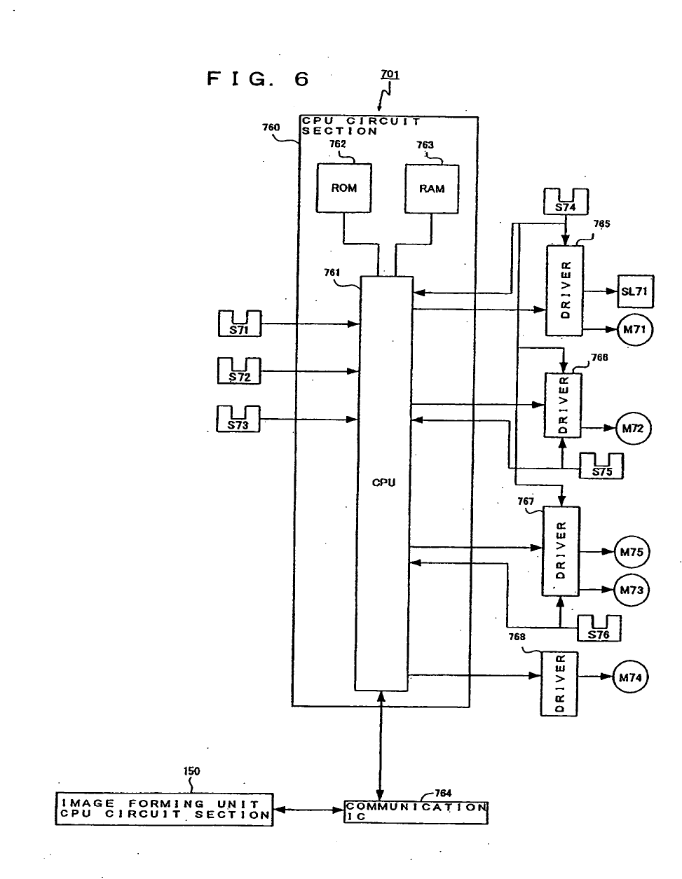

The structure of the finisher control section 701 for controlling the driving of the finisher 700 will be described with reference to FIG. 6. FIG. 6 is a block diagram showing the structure of the finisher control section shown in FIG. 2.

As shown in FIG. 6, the finisher control section 701 has a CPU circuit section 760 which is constituted of a CPU 761, a ROM 762, and a RAM 763. The CPU circuit section 760 communicates with the CPU circuit section 150 provided on the main body side of the image forming unit 10 through a communication IC 764 to exchange data and executes various kinds of programs stored in the ROM 762 according to instructions from the CPU circuit section 150 so as to control the driving of the finisher 700.

When performing this drive control, detection signals from various path sensors S71, S72, S73 provided on the CPU circuit section 760 and detection signals from detection sensors S74, S75, S76 for detecting the opening/closing state of the cover are inputted.

Drivers 765, 766, 767, 768 are connected to the CPU circuit section 760. The driver 765 drives a conveying motor M71 and flapper solenoid SL71 of the conveying processing module based on a signal from the CPU circuit section 760. The driver 766 drives a discharge motor M72 of non-sort discharge processing module based on a signal from the CPU circuit section 760. The driver 767 drives bundle conveying motors M73, M75 of sort discharge processing module based on a signal from the CPU circuit section 760. The driver 768 drives a tray lift motor M74 of stacking processing module based on a signal from the CPU circuit section 760.

Here, the conveying processing module includes a conveying motor M71 which is a drive source of the pair of the intake rollers 702 and the flapper solenoid SL71 for switching the switch flapper 710. The non-sort discharge processing module includes a discharge motor M72 which is a drive source for the pair of the conveying rollers 706 and the non-sort discharge roller 703. The sort processing module includes a sort discharge motor M75 which is a drive source for the sort discharge roller 704 and a bundle conveying motor M73 which is a drive source for the discharge rollers 705a, 705b. The stacking processing module includes a tray lift motor M74 which is a drive source for the stack tray 722.

The conveying motor M71, the non-sort discharge motor M72 and the sort discharge motor M75 are made of a stepping motor and are capable of rotating a pair of rollers at an equal speed or at an independent speed by controlling an excitation pulse rate of the motor. The bundle conveying motor M73 is composed of a DC motor.

The detection sensor S74 is a sensor for detecting the opening/closing state of a cover 751 described later. If it is detected that the cover 751 is open according to a detection signal from the detection sensor S74, the power supply of the driver 765 is turned off and at the same time when the drive of the conveying processing module is stopped forcibly, the power supply of the drivers 766, 767, 768 is turned off so that all the drives of the finisher 700 are stopped forcibly.

The detection sensor S75 is a sensor for detecting the opening/closing state of a cover 752 described later. If it is detected that the cover 752 is open according to a detection signal from the detection sensor S75, only the power supply of the driver 766 is turned off, so that only the driving of the non-sort processing module is stopped forcibly.

The detection sensor S76 is a sensor for detecting the opening/closing state of a cover 753 described later. If it is detected that the cover 753 is open according to a detection signal from the detection sensor S76, only the power supply of the driver 767 is turned off, so that only the drive of the sort processing module is stopped forcibly.

(Opening/Closing Member)

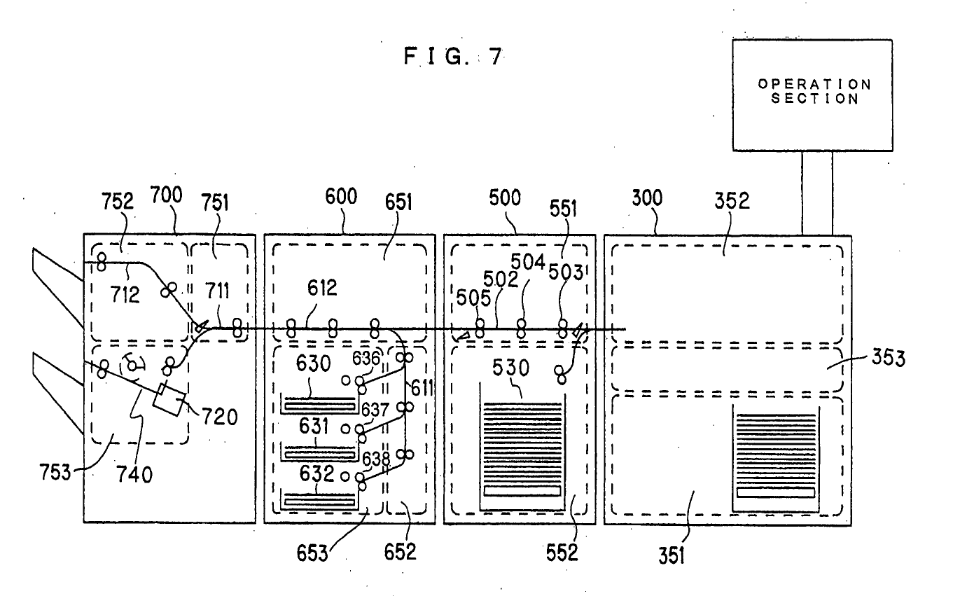

Next, the opening/closing members (hereinafter referred to as cover) provided externally on the printer 300, the sheet stacking unit 500, the inserter 600 and the finisher 700 will be described. FIG. 7 is a schematic view showing the disposition of the covers in the sheet processing system of the embodiment of the present invention.

The sheet stacking unit 500 is provided with the cover 551 for covering the horizontal path section including the horizontal conveying path 502 and the cover 552 for covering the sheet stacking section 530 such that they are capable of opening/closing. The cover 551 and the cover 552 can be opened/closed independently and these covers are opened/closed at maintenance time for jamming processing, part replacement, cleaning, adjustment and sheet removal. Further, the opening/closing of the respective covers 551, 552 are detected by means of the aforementioned detection sensors S54, S55.

The inserter 600 has the cover 651 for covering the horizontal path section including the horizontal conveying path 612, the cover 652 for covering the vertical conveying path 611, and the cover 653 for covering the sheet storage sections 630, 631, 632 and the feeding separating sections 636, 637, 638. The covers 651, 652, 653 can be opened/closed independently and these covers are opened/closed at a maintenance time for jamming processing, part replacement, cleaning, adjustment and sheet replenishment. The opening/closing state of the respective covers 651, 652, 653 are detected by means of the aforementioned detection sensors S64, S65, S66.

The finisher 700 has the cover 751 for covering the finisher path 711, the cover 752 for covering the non-sort path 712 and the cover 753 for covering the staple processing section including the stapler 720. The respective covers 751, 752, 753 can be opened/closed independently and these covers are opened/closed at a maintenance time for jamming processing, part replacement, cleaning and adjustment. The opening/closing state of each of the covers 751, 752, 753 is detected by the aforementioned detection sensors S74, S75, S76.

The printer 300 is provided with a cover 351, a cover 352 and a cover 353. The cover 351 is a cover for covering the sheet replenishing section. The cover 352 is a cover for covering the photosensitive drum 111, the transfer section 116, the fixing section 117, the flapper 121 and a conveying path for introducing a sheet. When forming an image on a single face or double faces, the sheet is conveyed on the conveying path. The cover 353 is a cover for covering the double-side conveying path 124. The cover 351, the cover 352 and the cover 353 can be opened or closed independently and these covers are opened/closed at a maintenance time for jamming processing, part replacement, cleaning, adjustment and sheet replenishment. The opening/closing state of each of the respective covers 351, 352, 353 is detected by a detection sensor (not shown) for detecting the opening/closing state of the cover like the sheet stacking unit 500, the inserter 600 and the finisher 700.

(Operation of Sheet Processing System)

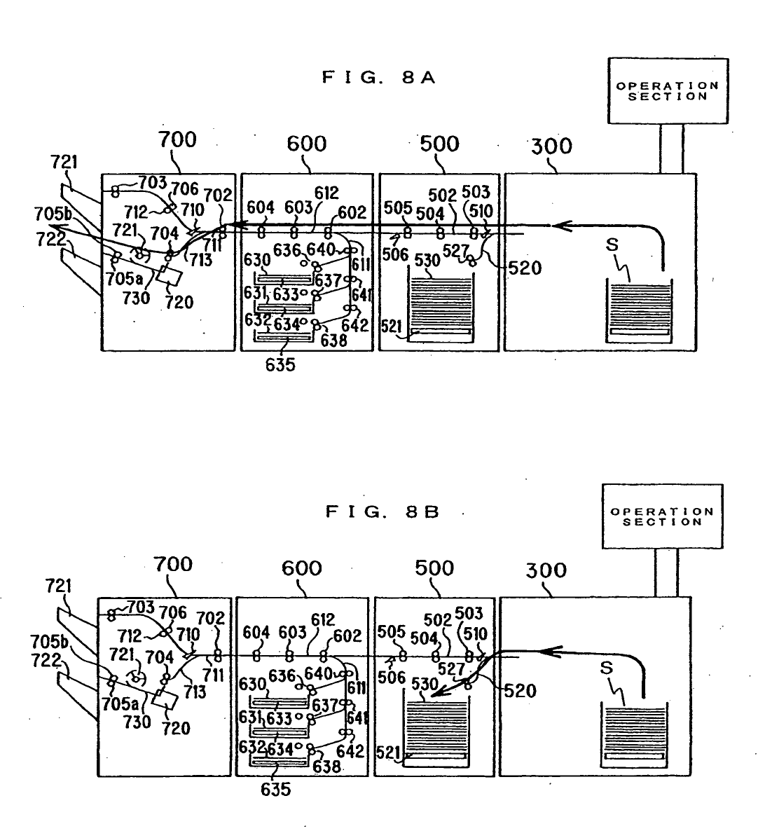

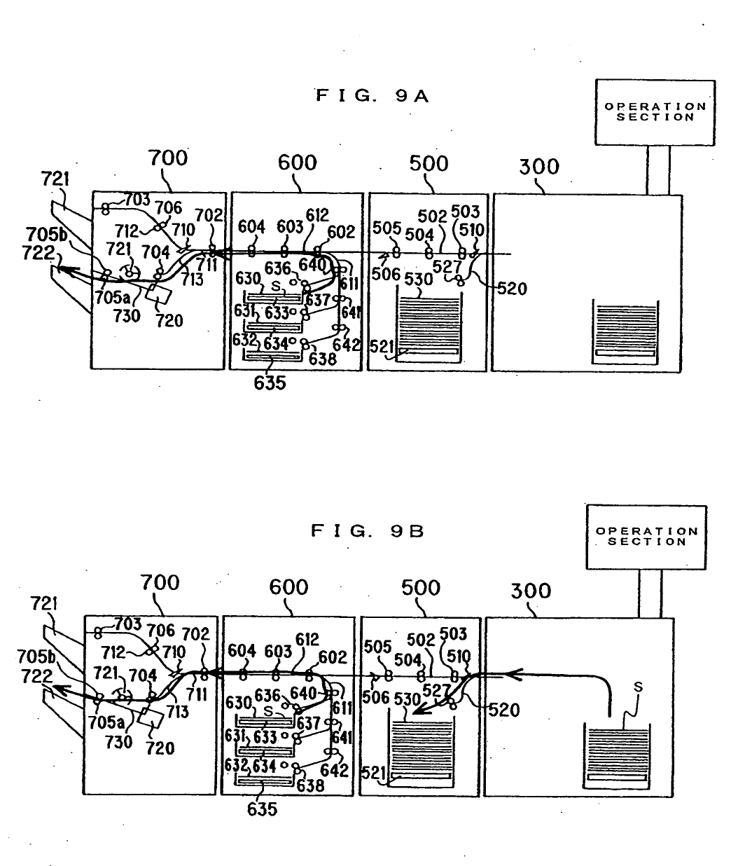

The operation of the sheet processing system A will be described with reference to FIGS. 8 to 9. FIGS. 8A, 8B and FIGS. 9A, 9B are schematic sectional views showing schematically the sheet processing operation of the sheet processing system of this embodiment.

[Operation 1: Stapling after an Image is Formed] (see FIG. 8A)

As shown in FIG. 8A, after an image is formed by the printer 300, the sheet S is introduced by the switch flapper 510 turned off to the horizontal conveying path 502 in the sheet stacking unit 500 and passes the horizontal conveying path 612 of the inserter 600. Then, the sheet S is introduced by the switch flapper 710 turned off to the sort path 713 and stacked on the intermediate tray 730 through the sort discharge roller 704. The sheets S stacked on the intermediate tray 730 in the form of a bundle undergo alignment, stapling and the like if necessary and after that, are discharged onto the stack tray 722 by means of the discharge rollers 705a, 705b. Stapling of the sheets stacked on the intermediate tray 730 in the form of a bundle is carried out by the stapler 720. The stack tray 722 descends depending on the stacking amount of the sheets S.

At this time, the image forming unit CPU 150 actuates the flapper solenoid SL51 and the horizontal path conveying motor M51 for selecting the sheet stacking path through the sheet stacking unit CPU 561. Further, it actuates the horizontal path conveying motor M61 through the sheet feeding unit CPU 661. Additionally, it actuates the flapper solenoid SL71 for switching the path through the finisher CPU 761, the conveying motor M71, the sort discharge motor M75, the bundle conveying motor M73, and the tray lift motor M74. Other flapper solenoid or motor is not actuated.

[Operation 2: Stacking after an Image is Formed] (see FIG. 8B)

As shown in FIG. 8B, after an image is formed by the printer 300, the sheet S is introduced to the path 520 by the switch flapper 510 turned on and then, stacked on the sheet stacking section 530 successively by the conveying roller 527. The sheet stacking plate 521 descends depending on the stacking amount of the sheet.

At this time, the image forming unit CPU 150 actuates the flapper solenoid SL51 for selecting the sheet stacking path, the sheet stacking conveying motor M53, and the sheet stacking plate motor M52 through the sheet stacking unit CPU 561. At this time, other flapper solenoid or motor is not actuated.

[Operation 3: Stapling after Feeding from Sheet Feeding Unit] (see FIG. 9A)

As shown in FIG. 9A, after fed from the inserter 600, the sheet S passes the feeding longitudinal path 611 and the horizontal conveying path 612 and is introduced to the finisher 700. Further, the sheet S is introduced to the sort path 713 by the switch flapper 710 turned off and stacked on the intermediate tray 730 through the sort discharge roller 704. After stacked on the intermediate tray 730 in the form of a bundle, the sheets S undergo alignment, stapling and the like if necessary and after that, are discharged onto the stack tray 722 by the discharge rollers 705a, 705b. The stapling processing of binding the sheets stacked in the form of a bundle on the intermediate tray 730 is executed by the stapler 720. The stack tray 722 descends depending on the stacking amount of the sheets S.

At this time, the image forming unit CPU 150 actuates the feeding separating section motor M63, the intermediate plate lift motor M64, the feeding longitudinal path conveying motor M62, and the horizontal path conveying motor M61 through the sheet feeding unit CPU 661. Further, the image forming unit CPU 150 actuates the flapper solenoid SL71 for switching the path, the conveying motor M71, the sort discharge motor M75, the bundle conveying motor M73, and the tray lift motor M74 through the finisher CPU 761. Other flapper solenoid or motor is not actuated.

[Operation 4: Parallel Processing (Operation 2+Operation 3) (see FIG. 9B)

After the image formation of the operation 2, the sheet processing system of this embodiment is capable of executing jobs in parallel if stapling processing is instructed by feeding the sheets from the sheet feeding unit of the operation 3 while the stacking processing is carried out.

At this time, the image forming unit CPU 150 executes the operations 2, 3 in parallel through the sheet stacking unit CPU 561, the sheet feeding unit CPU 661 and the finisher CPU 761.

At this time, the parallel flapper 506 disposed on the side of the sheet feeding unit of the sheet stacking unit 500 is turned on so as to intercept the downstream (side of the inserter 600) of the horizontal conveying path 502. Even if the sheet S in the job of the operation 2 is not introduced to the path 520 due to a fault of the switch flapper 510 and sent to the horizontal conveying path 502, it is intercepted by the parallel flapper 506. Since no sheet is sent to the inserter 600 executing the job of the operation 3, the sheets S processed by different jobs can be prevented from mixing with one another, thereby improving the reliability.

(Opening/Closing Covers)

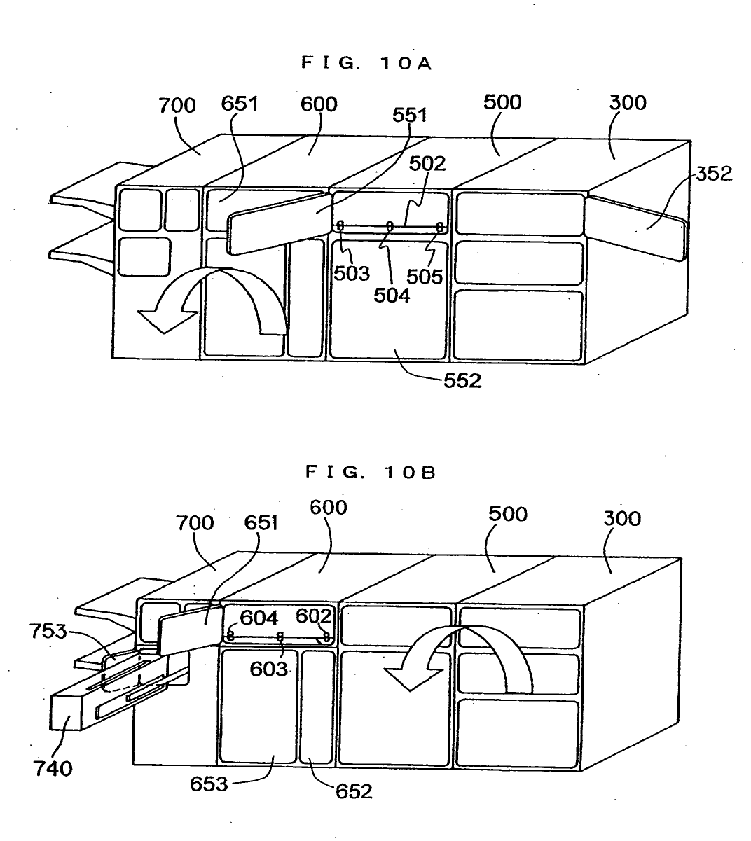

Next, the procedure for opening/closing the cover will be described with reference to FIG. 10. FIG. 10 is a perspective view showing schematically a condition in which the covers of the sheet processing system are partially opened.

When the cover 551 provided on the sheet stacking unit 500 is opened as shown in FIG. 10A, the horizontal conveying path 502 and the pairs of the respective conveying rollers 503, 504, 505 disposed internally can be accessed from out of machine. When the cover 352 provided on the printer 300 is opened, the photosensitive drum 111 and the fixing section 117 disposed internally can be accessed from out of the machine. When the other cover is opened, internal components and units can be accessed from out of the machine.

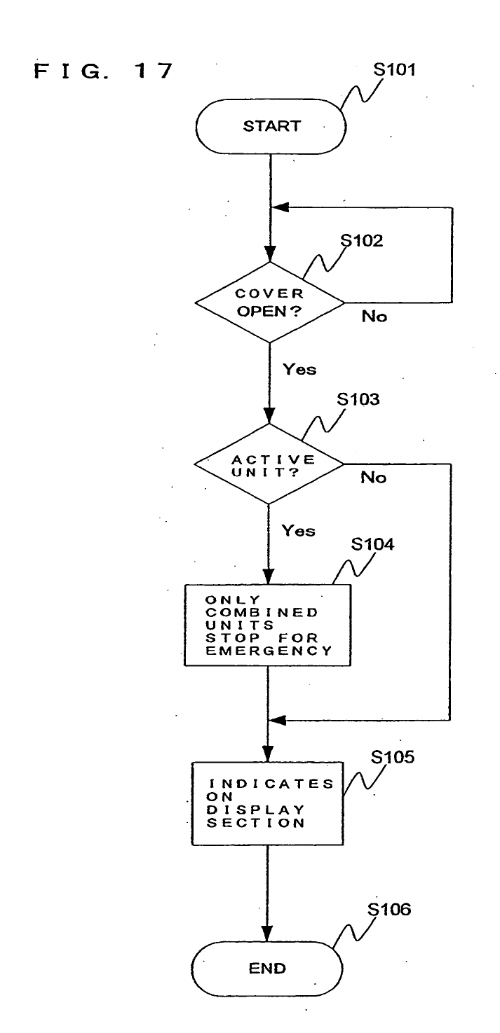

A case where the operation 3 in which the inserter 600 and the finisher 700 are combined is executed as the job 1 (first processing) will be described. FIG. 17 is a flow chart for explaining the operation of system when the cover is opened or closed while a job is being executed.

First, when the cover 551 is opened while the sheet processing system A is starting a job (S101), the opening/closing state of the cover 551 is detected by the detection sensor S54 and this information is sent to the CPU circuit section 560. With information sent to the CPU circuit section 150 through the communication IC 564, the CPU circuit section 150 determines that the cover 551 is opened (S102).

The CPU circuit section 150 recognizes that the horizontal conveying path 502 and the pairs of the respective conveying rollers 503, 504, 505, which can be accessed when the cover 551 is opened, are not used for the job 1 containing the operation 3. Therefore, it determines that those units are not active (S103), controlling so as to continue the job 1 without stopping of the operation 3 when the cover 551 is opened (S106).

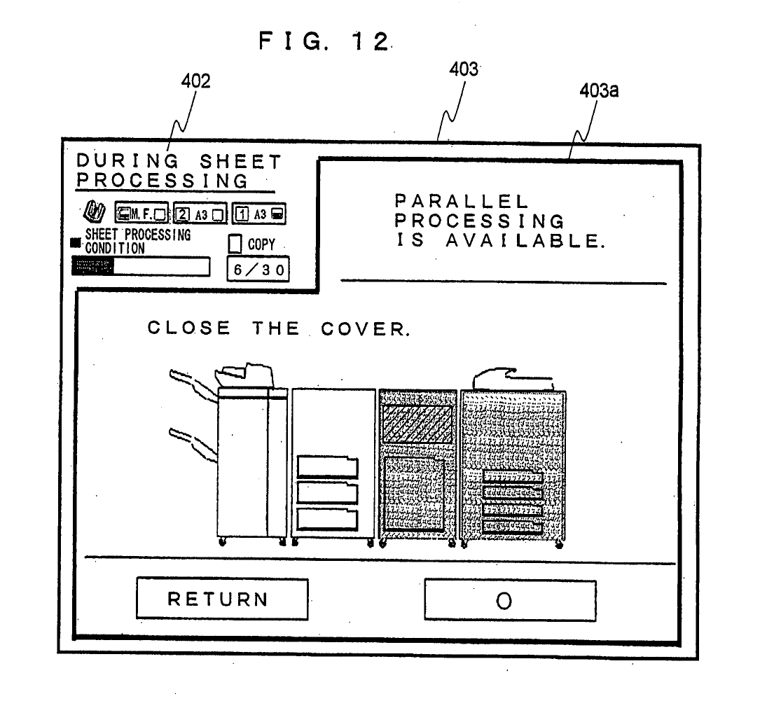

On the other hand, the image forming unit CPU 150 sends information for notifying the opening state of the cover 551 to the display control section 401, which is notifying means and makes the operation display unit 400 display (notify) information to the user (S104). More specifically, as shown in FIG. 12, it is indicated that the cover 551 is open with the hatching in a window 403a provided in the display section 403 of the operation display unit 400 and displays a message saying “close the cover”. Here, the window 403a indicates a message saying “sheet is being processed” to express that the sheet processing of the operation 3 is being executed as the job 1.

If the other covers 552, 351, 352, 353 are opened, because these are the covers of units not used for the operation 3, the CPU circuit section 150 controls to continue the job 1 without stopping the operation 3 as described above. Then, the CPU circuit section 150 controls the operation display unit 400 to indicate instructions to the user.

Even if any cover not concerning the operation 3 selected in the job 1 is opened or closed as described above, the job 1 is not affected at all. Therefore, these covers can be opened or closed for setting for maintenance of unit and executing other job or a processing when other job ends.

That is, if the CPU circuit section 150 detects that the cover 551 provided on the sheet stacking unit 500 not used for the job 1 is opened by means of the detection sensor S54, it controls the inserter 600 and the finisher 700 used for the job 1 not to stop. Consequently, it is possible to provide a sheet processing system A having a high productivity. Since even if any job is not finished, part of the opening/closing member can be opened or closed, for example, replacement of consumption part, maintenance including repair of a fault portion, setting work for executing other job and a processing when other job ends can be executed without stopping the entire sheet processing system.

If the cover 651 of the inserter 600 is opened as shown in FIG. 10B, the horizontal conveying path 612 and the pairs of the respective conveying rollers 602, 603, 604 can be accessed from outside of the machine. Further, if the cover 753 of the finisher 700 is opened, the sort processing section 740 can be taken out of the machine so that it can be accessed from out of the machine. The same thing can be said of the other covers for the inserter 600 and the finisher 700.

Next, a case of executing the operation 2 in which the printer 300 and the sheet stacking unit 500 are combined as the job 1 (first processing) is considered.

If the cover 651 is opened in a state that the sheet processing system A is starting the job (S101), the cover detection sensor S64 detects that the cover 651 is opened or closed and this information is sent to the CPU circuit section 660. According to the information sent to the CPU circuit section 150 through the communication IC 664, the CPU circuit section 150 determines that the cover 651 is opened (S102).

The CPU circuit section 150 recognizes that the horizontal conveying path 612 and the pairs of the conveying rollers 602, 603, 604 which can be accessed when the cover 651 is opened are not being used during execution of the operation 2. Thus, it determines that they are not active (S103) and controls so as to continue the job 1 without being stopped of the operation 2 even if the cover 651 is opened (S106).

On the other hand, the CPU circuit section 150 of the image forming unit sends information for notifying the display control section 401, which is notifying means also that the cover 551 is open so as to make the operation display unit 400 display (notify) information to the user (S104). More specifically, a message saying “close the cover” is displayed in the window 403a provided on the display section 403 of the operation display unit 400. The window 403a has a message section indicating “sheet is being processed” so as to express that the print processing of the operation 2 is being continued as the job 1.

When the other covers 652, 653, 751, 752, 753 are opened, the CPU circuit section controls so as to continue the job 1 without stopping the operation 2 as described above, because these covers are not used for the operation 2. Then, the operation display unit 400 controls to display the information to the user.

As described above, even if any cover not concerning the operation 2 selected in the job 1 is opened or closed, the job 1 is not affected at all. Thus, these covers can be opened or closed for maintenance of the unit, setting work for executing other job or a processing when other job ends.

That is, if the CPU circuit section 150 detects that the cover 651 provided on the inserter 600 not used for the job 1 is open by means of the cover detection sensor S64, it controls the printer 300 and the sheet stacking unit 500 used for the job 1 not to stop. Thus, it is possible to provide a sheet processing system A having a high productivity. Further because part of the opening/closing members can be opened/closed even if any job is not finished, for example, replacement of consumption part, maintenance including repair of a fault portion or the like, setting work for executing other job or a processing when other job ends can be executed without stopping the entire sheet processing system.

Next, in the sheet processing system A having plural sheet processing units each having a sheet processing function and capable of executing plural jobs in parallel by one of the sheet processing unit or by combining plural sheet processing units, a case where the operation 2 in which the printer 300 and the sheet stacking unit 500 are combined as the job 1 (first processing) and the operation 3 in which the inserter 600 and the finisher 700 are combined as the job 2 (second processing) are executed in parallel (operation 4) is considered.

If the operation 4 is executed and then the cover 551 is opened when the sheet processing system A is starting the jobs 1, 2 (S101), the detection sensor S54 detects that the cover 551 is opened or closed and this information is sent to the CPU circuit section 560. Further, according to information sent to the CPU circuit section 150 of the image forming unit through the communication IC 564, the CPU circuit section 150 determines that the cover 551 is opened (S102).

The CPU circuit section 150 recognizes that the horizontal conveying path 502 and the respective pairs of the conveying rollers 503, 504, 505 which can be accessed through an opening when the cover 551 is opened are used for the operation 2 (job 1). Thus, the CPU circuit section 150 determines that they are active (S103) and controls that when the cover 551 is opened, the operation 2 stops immediately so as to interrupt the job 1 (S105). More specifically, the power supply of the horizontal path conveying motor M51 which is a drive source for the pairs of the conveying rollers 503, 504, 505, is turned off. At the same time, the power supplies of the flapper solenoid SL51 for switching the path switching flapper 510 activated in the operation 2, the flapper solenoid SL 52 for switching the path switching flapper 506, the sheet stacking plate motor M52 which is a drive source for the sheet stacking plate 521, and the sheet stacking conveying motor M53 which is a drive source of the conveying roller 527 are turned off. Further, the drive of the printer 300 activated in combination of those components is stopped forcibly so as to stop the operation 2.

However, the inserter 600 and the finisher 700 activated in the operation 3 executed in parallel to the operation 2 can continue the operation 3. That is, the CPU circuit section 150 recognizes that the horizontal conveying path 502 and the respective pairs of the conveying rollers 503, 504, 505 which can be accessed through an opening when the cover 551 is opened are not used for the operation 3 (job 2). Therefore, the CPU circuit section 150 determines that the sheet stacking unit 500 is not a unit used for the operation 3 (S103) and independently controls so as to continue the job 2 without stopping the operation 3 when the cover 551 is opened and at the same time, stops the printer 300 and the sheet stacking unit 500 combined for the operation 2 immediately.

As described above, when the cover 551 is opened, only the operations (operation 2) of the sheet stacking unit 500 provided with the cover 551 and the printer 300 combined therewith stop immediately so as to interrupt the job 1. On the other hand, the operations (operation 3) of the inserter 600 and the finisher 700 not used in the job 1 are continued and the job 2 is continued.

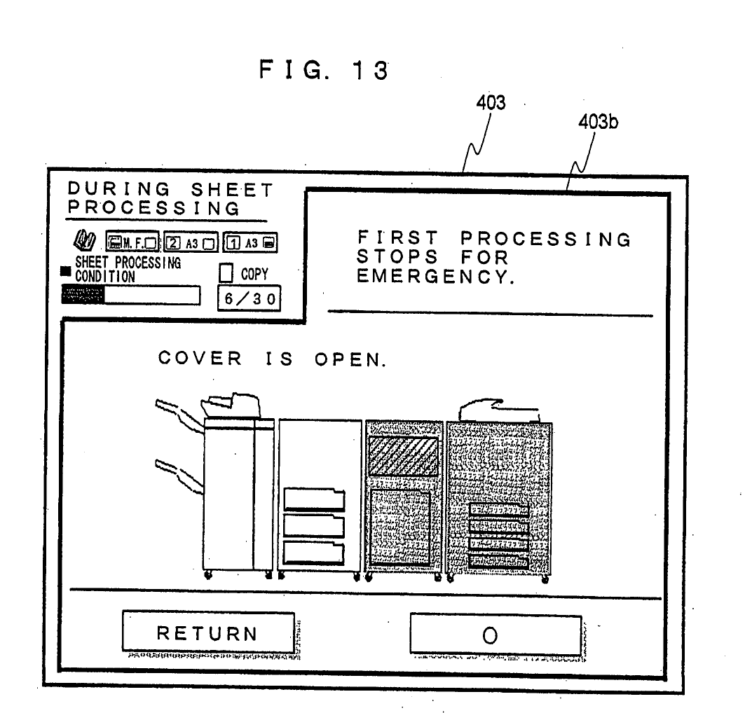

On the other hand, the CPU circuit section 150 sends information for notifying the display control unit 401 which is notifying means that the cover 551 is open so as to make the operation display unit 400 display (notify) the information to the user (S104). More specifically, as shown in FIG. 13, it is indicated that the cover 551 is open with a hatching in the window 403b provided in the display section 403 of the operation display unit 400 and a message saying “the cover is open” is expressed. Further, to notify that the job 1 is stopped for emergency, a message saying “the first processing is stopped for emergency” is displayed. The window 403b displays a message saying “sheet is being processed” so as to indicate that the sheet processing of the operation 3 is being continued as the job 2.

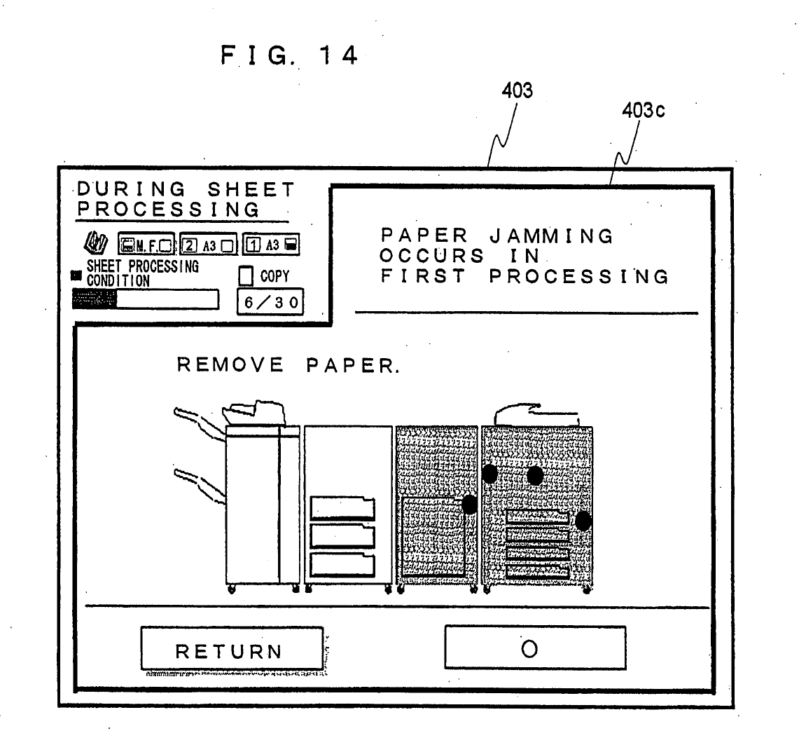

The operation display unit 400 indicates that paper jamming occurs due to the emergency stop in the window 403c provided in the display section 403 and displays (notify) a message saying “paper jamming occurs in the first processing” (see FIG. 14). Further, a paper jamming portion is indicated with a black dot in FIG. 14 for the user to be capable of seeing the position of the paper jamming.

At this time, other covers 552, 351, 352, 353 of units combined in the operation 2 halted can be opened/closed freely. That is, the CPU circuit section 150 determines that they are not active (S103) and controls so as to continue the job 2 without stopping of the operation 3 even if any cover is opened (S106).

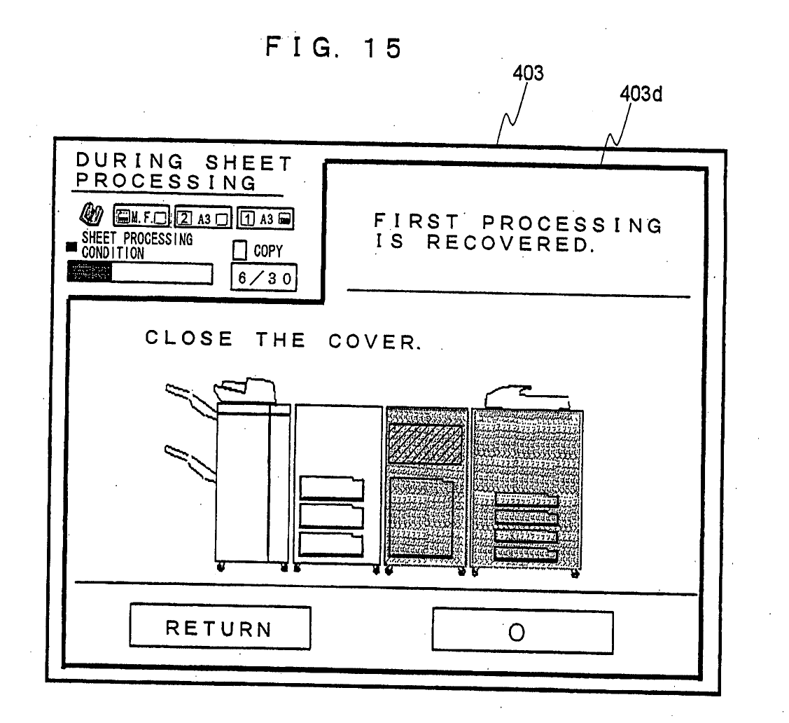

Then, when the user completes jamming processing, a message saying “close the cover” is displayed in the window 403d as shown in FIG. 15 so as to urge the user to close the cover and when the cover is closed, the interrupted job 1 is recovered and then the operation 2 is restarted. In this while, the sheet processing of the operation 3 as the job 2 is continued.

The same control is made even if the cover opened first is not the aforementioned cover 551, and the other covers 351, 352, 353, 552 of the printer 300 and sheet stacking unit 500 are opened.

As for the condition for emergency stop, the same control is made not only when the cover is opened, but also when for example, the printer 300 stops due to sheet jamming or consumption of developer.

That is, even if paper jamming occurs at any location about the operation 2, for example, in the horizontal conveying path 502, the power supply of the horizontal path conveying motor M51 which is a drive source for the pairs of the conveying rollers 503, 504, 505, is turned off. At the same time, the power supplies of the flapper solenoid SL51 for switching the path switching flapper 510 activated in the operation 2, the flapper solenoid SL52 for switching the path switching flapper 506, the sheet stacking plate motor M52 which is a drive source of the sheet stacking plate 521, and the sheet stacking conveying motor M53 which is a drive source of the conveying roller 527, are turned off. Further, all the drive of the printer 300 activated in combination is stopped forcibly and the operation 2 is stopped.

The inserter 600 and the finisher 700 activated in the operation 3 can continue the operation 3 and the covers of the units 551, 552, 351, 352, 353 combined in the operation 2 halted can be opened or closed freely. That is, the CPU circuit section determines that they are not active (S103) and controls that even if any cover is opened, the job 2 is continued without stopping the operation 3.

Further if any error relating to image formation occurs in the printer 300, while the operation 3 is not stopped but the job 2 is continued, the covers of the units relating to the operation 2 can be opened/closed.

The same thing occurs in an opposite case to the above-described one. That is, if the cover for the inserter 600 or the finisher 700 is opened during the execution of the operation 4, the operation 2 is continued as the job 1 and only the operation 3 of the job 2 is stopped.

If paper jamming or other error occurs in the inserter 600 or the finisher 700, the covers of units relating to the operation 3 can be opened or closed while the job 1 is continued without stopping the operation 2.

If the CPU circuit section 150 detects that the any cover of the units relating to the job 1 is open by means of the detection sensor, the stop control for the job 1 which uses a portion accessible through an opening in the cover can be carried out independently of the other job 2 which does not use a portion accessible through the opening in the opening/closing member. Thus, it is possible to provide a sheet processing system having a high productivity.

Because the covers are divided for each conveying path not to provide any obstacle to parallel processing, even if the cover is opened or closed for jamming processing, part replacement, cleaning, adjustment or maintenance for sheet replenishment in a unit relating to any one of two jobs processed in parallel, only the unit requiring the maintenance needs to be stopped. Therefore, the operation executed by the unit relating to the other job is continued, thereby providing a sheet processing system ensuring a high productivity.

Instead of the aforementioned display unit 400, it is permissible to notify the activation condition of the sheet processing system for the user through blinking of a LED which is a light emitting unit (not shown) or beep sound from a speaker which is a sound production unit.

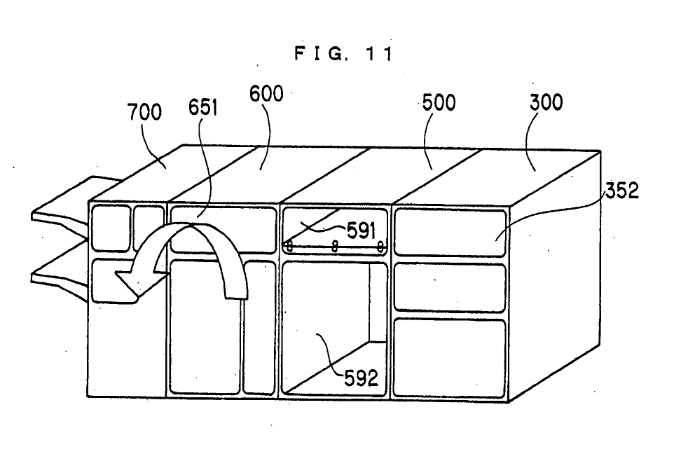

FIG. 11 is a schematic perspective view of the sheet stacking unit 500 for explaining partition walls of this embodiment while the covers 551, 552 and their contents are not expressed. The partition walls 591, 592 limit an access from the sheet stacking unit 500 to the inserter 600 and an access in the opposite direction. This prevents an access from the side of the sheet stacking unit 500 to the inserter 600 when the operation 3 from being performed, and therefore prevents the execution of the operation 3 from being hindered (for example, making contact with a sheet being conveyed or a path sensor). The same thing can be said of an access from the side of the inserter 600 to the sheet stacking unit 500 during execution of the operation 2. The same thing can be said of a case where the operation 4 is being carried out.

Although in the description of this embodiment, the drive sources are divided for each path, the structure of this embodiment is not restricted to this example. For example, the discharge roller 118 of the printer 300 and the horizontal conveying path 502 of the sheet stacking unit 500 may be driven by the same driving source. Further, the horizontal conveying path 612 of the inserter 600 and the pair of the intake rollers 702 of the finisher 700 may be driven by the same drive source.

The cover 352 of the printer 300 and the cover 551 of the sheet stacking unit 500 may be of the same cover. The cover 651 of the inserter 600 and the cover 751 of the finisher 700 may be of the same cover. That is, there is no obstacle in sharing any components among units relating to the same jobs.

Second Embodiment

(Locking Mechanism)

According to the present invention, the cover which can be opened/closed is provided with a locking mechanism, which can be operated selectively.

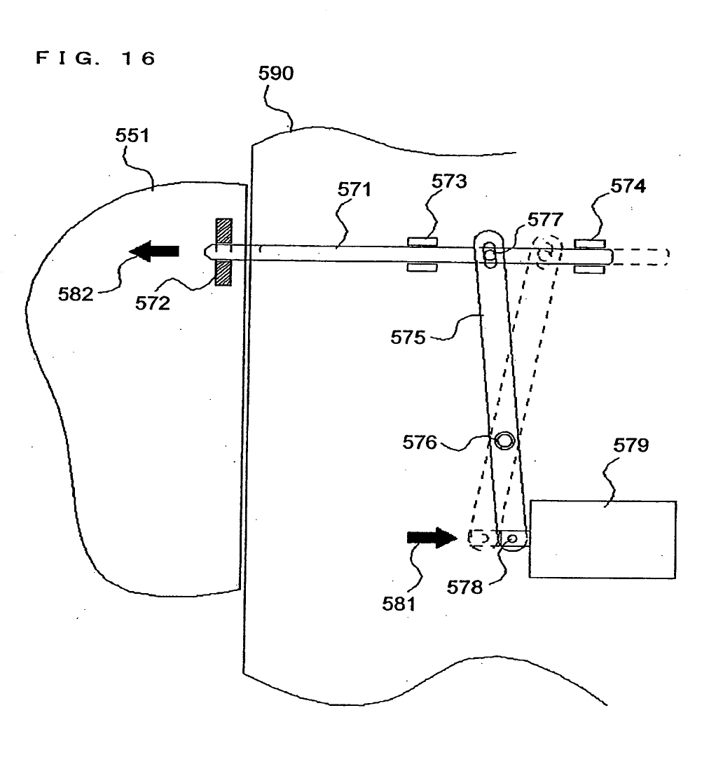

FIG. 16 is a schematic view of the cover 551 of the sheet stacking unit 500 for explaining the locking mechanism of this embodiment viewed from the inside the unit. A lock bar 571 is attached to a frame 590 of the sheet stacking unit 500 such that it is capable of advancing or retracting along guides 573, 574. A link 575 is pivotable about a pivot 576 while an end thereof is engaged with a lock bar 571 through a pin 577 and the other end is engaged with a lock solenoid 579 through a pin 578.

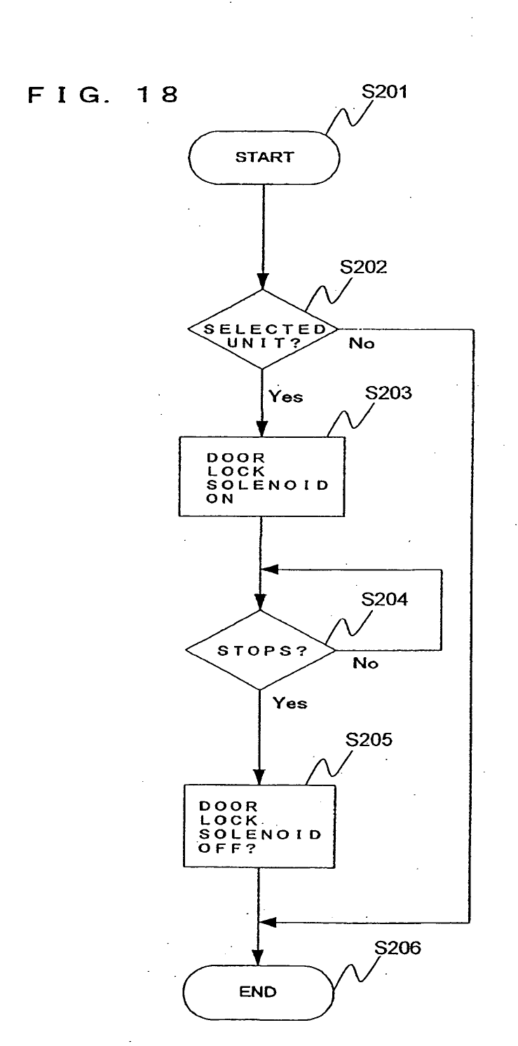

Next, the operation of the lock mechanism of this embodiment will be described with reference to FIG. 18. FIG. 18 is a flow chart for explaining the operation of the locking mechanism of a second embodiment.

Firstly, with the power supply of the sheet processing system A turned on (S201), any sheet processing unit for carrying out an action included in a job, for example, the horizontal conveying path 502 of the sheet stacking unit 500 is selected (S202). When any job of the sheet processing system is started, the lock solenoid 579 of the lock mechanism of the cover 551 corresponding thereto is turned on (S203). The lock solenoid 579 is pulled in the direction of an arrow 581 in FIG. 16 and the link 575 pivots from a state indicated with a dotted line in FIG. 16 to a position indicated with a solid line. Then, the lock bar 571 slides in the direction of an arrow 582 and is inserted into a lock hole 572 provided in the cover 551, so that the cover 551 is locked and becomes unopenable.

The same operation is executed for any cover of a selected unit.

For example, when the operation 2 in which the printer 300 and the sheet stacking unit 500 are combined is executed as the job 1 (first processing), the respective covers 551, 552, 351, 352, 353 are locked. Thus, it is possible to prevent these covers from being opened by the user by mistake. On the other hand, needless to say, the respective covers of the inserter 600 and the finisher 700, which have not been selected, can be opened or closed freely.

When the job 1 ends or the operation 2 stops due to sheet jamming or error in the printer 300, the sheet stacking unit 500 (S204), the lock solenoid 579 is turned off so as to release the lock bar 571 and locking of other cover is released, so that these covers can be opened or closed (S205). The error mentioned here refers to a case where any job is stopped forcibly because consumption parts such as sheets, developer need to be replenished.

Next, a case where the operation 2 in which the printer 300 and the sheet stacking unit 500 are combined as the job 1 (first processing) and the operation 3 in which the inserter 600 and the finisher 700 are combined as the job 2 (second processing) are executed in parallel (operation 4) is considered.

In this case, when each job is started, the corresponding lock of a cover is activated.

If paper jamming occurs at any location in the operation 2, for example, in the horizontal conveying path 502, the power supply of the horizontal path conveying motor M51 which is a drive source for the pairs of the conveying rollers 503, 504, 505 is turned off. At the same time, the power supplies of the flapper solenoid SL51 for switching the path switching flapper 510 activated in the operation 2, the flapper solenoid SL52 for switching the path switching flapper 506, the sheet stacking plate motor M52 which is a drive source for the sheet stacking plate 521, and the sheet stacking conveying motor M53 which is a drive source of the conveying roller 527 are turned off. The drive of the printer 300 activated in combination is stopped forcibly so as to stop the operation 2.

The inserter 600 and the finisher 700 activated in the operation 3 can continue the operation 3 and only the covers 551, 552, 351, 352, 353 of the units used in combination in the stopped operation 2 are unlocked, so that those covers can be opened/closed freely.

To unlock only the lock mechanism of the opening/closing member of the sheet processing unit in which jamming or error occurs, the covers of the inserter 600 and finisher 700 are kept locked so that they can be prevented from being opened by the user by mistake.

In the meantime, each unit mentioned in the present invention is not always restricted to that constructed in the form of a case.

In the operation 1 shown in FIG. 8A, the horizontal conveying paths 502, 612 of the sheet stacking unit 500 and the inserter 600 are units used for the operation 1. On the other hand, the sheet stacking section 530 and the sheet storage sections 630, 631, 632 are not used in this operation 1. Even if the covers 552, 652, 653 are opened in this case, the operation 1 is not stopped but the job is executed continuously. The covers 551, 651 are locked and cannot be opened during the operation.

The above-described embodiments are summarized as follows.

(1) A sheet processing system A which includes plural sheet processing units each having sheet processing function (printer 300, sheet stacking unit 500, inserter 600, finisher 700), and which is capable of executing plural jobs 1, 2 of sheet processing in parallel, each job being actuated by one of the sheet processing units or by a combination of plural sheet processing units (for example, printer 300 and the sheet stacking unit 500, inserter 600 and the finisher 700), the sheet processing system comprising: opening/closing members (covers 551, 552) provided on each of the sheet processing units (for example, sheet stacking unit 500) to be accessible to the interior of the sheet processing unit; sensors (detection sensors S54, S55) which detect the opening/closing state of the opening/closing member; and a controller (CPU circuit section 150) which controls a stop of the sheet processing unit according to a signal from the sensor, wherein when the sensor (detection sensor S54) detects that any of the opening/closing members (covers 551, 552) is open, the controller carries out stop control for a job 1 using a portion accessible (horizontal conveying path 502 and pairs of conveying rollers 503, 504, 505) through an opening in the opening/closing member (cover 551) and a job 2 not using a portion accessible through an opening in the opening/closing member (cover 551) independently.

Consequently, in the sheet processing system capable of executing plural jobs in parallel, even if the cover of the sheet processing unit used for a job needs to be opened for jamming or maintenance, the stop control can be executed for each job independently. Thus, the other job can be continued without stopping. Consequently, a sheet processing ensuring a high productivity can be achieved.

(2) A sheet processing system A which includes plural sheet processing units each having sheet processing function (printer 300, sheet stacking unit 500, inserter 600, finisher 700), and which is capable of executing plural jobs 1, 2 of sheet processing in parallel, each job being actuated by one of the sheet processing units or by a combination of plural sheet processing units (for example, printer 300 and the sheet stacking unit 500, inserter 600 and the finisher 700), the sheet processing system comprising: opening/closing members (covers 551, 552) provided on each of the sheet processing units (for example, sheet stacking unit 500) to be accessible to the interior of the sheet processing unit; sensors (detection sensors S54, S55) which detect the opening/closing state of the opening/closing member; and a controller (CPU circuit section 150) which controls a stop of the sheet processing unit according to a signal from the sensor, wherein when the sensor (detection sensor S54) detects that the opening/closing member (cover 551) provided on a sheet processing unit used for the job 1 is open, the controller stops only the sheet processing unit (sheet stacking unit 500) used for the job 1 and other sheet processing unit (printer 300) actuated in combination with the sheet processing unit.

Consequently, in the sheet processing system capable of executing plural jobs in parallel, even if the cover is opened during execution of a job, only the sheet processing unit provided with that cover and the sheet processing unit actuated in combination with the sheet processing unit are stopped and consequently, a job for actuating other sheet processing units is executed without an interruption. Thus, a sheet processing having a high productivity can be achieved.

(3) A sheet processing system A which includes plural sheet processing units each having sheet processing function (printer 300, sheet stacking unit 500, inserter 600, finisher 700), and which is capable of executing plural jobs 1, 2 of sheet processing in parallel, each job being actuated by one of the sheet processing units or by a combination of plural sheet processing units (for example, printer 300 and the sheet stacking unit 500, inserter 600 and the finisher 700), the sheet processing system comprising: opening/closing members (covers 551, 552) provided on each of the sheet processing units (for example, sheet stacking unit 500) to be accessible to the interior of the sheet processing unit; sensors (detection sensors S54, S55) which detect the opening/closing state of the opening/closing member; and a controller (CPU circuit section 150) which controls a stop of the sheet processing unit according to a signal from the sensor, wherein when it is detected that the opening/closing member (cover 551) provided on the sheet processing unit (sheet stacking unit 500) not used for the job 1 is open, the controller does not stop the sheet processing unit (inserter 600 and finisher 700) used for the job 1.

Consequently, in the sheet processing system capable of executing plural jobs in parallel, the sheet processing unit used for a job is not stopped when the cover provided on a sheet processing unit not used for a job is opened or closed. Thus, replacement of a consumption part or maintenance can be executed without waiting for an end of a job, thereby achieving an effective working.

(4) A sheet processing system A which includes plural sheet processing units each having sheet processing function (printer 300, sheet stacking unit 500, inserter 600, finisher 700), and which is capable of executing plural jobs 1, 2 of sheet processing in parallel, each job being actuated by one of the sheet processing units or by a combination of plural sheet processing units (for example, printer 300 and the sheet stacking unit 500, inserter 600 and the finisher 700), the sheet processing system comprising: opening/closing members (covers 551, 552) provided on each of the sheet processing units (for example, sheet stacking unit 500) to be accessible to the interior of the sheet processing unit; sensors (detection sensors S54, S55) which detect the opening/closing state of the opening/closing member; notifying means (operation display unit 400) which notifies the opening state of the opening/closing member detected by the sensor; and a controller (CPU circuit section 150) which controls a stop of the sheet processing unit according to a signal from the sensor, wherein when the sensor (detection sensor S54) detects that the opening/closing member (cover 551) provided on the sheet processing unit (sheet stacking unit 500) used for the job 1 is open, the controller stops only the sheet processing unit (sheet stacking unit 500) used for the job 1 and the other sheet processing unit (printer 300) actuated in combination with the sheet processing unit, and the notifying means (operation display unit 400) notifies (displays) that the sheet processing unit is stopped.

Consequently, an operator of the sheet processing system can know whether or not the cover is open easily and it is possible to prevent the cover provided on the sheet processing unit used for the job from being opened by mistake.

(5) The sheet processing system described in the (4) above wherein the notifying means is at least any one of a display unit (operation display unit 400), a light emission unit (LED) and a sound production unit (speaker).

(6) A sheet processing system A which includes plural sheet processing units each having sheet processing function (printer 300, sheet stacking unit 500, inserter 600, finisher 700), and which is capable of executing plural jobs 1, 2 of sheet processing in parallel, each job being actuated by one of the sheet processing units or by a combination of plural sheet processing units (for example, printer 300 and the sheet stacking unit 500, inserter 600 and the finisher 700), the sheet processing system comprising: opening/closing members (covers 551, 552) provided on each of the sheet processing units (for example, sheet stacking unit 500) to be accessible to the interior of the sheet processing unit; sensors (detection sensors S54, S55) which detect the opening/closing state of the opening/closing member; a controller (CPU circuit section 150) which controls a stop of the sheet processing unit according to a signal from the sensor; and a locking mechanism which prevents the opening/closing member from being opened, wherein the controller controls the locking mechanism to prevent the opening/closing member provided on the sheet processing unit used for the job 1 from being opened.

Consequently, it is possible to prevent the opening/closing member provided on the sheet processing unit used for a job from being opened by mistake.

(7) The sheet processing system described in the (6) above wherein when a jamming or error occurs in the sheet processing system used for the job, the controller releases only the locking mechanisms of an opening/closing member provided on a sheet processing unit used for the job and other sheet processing unit actuated in combination with the sheet processing unit.

Consequently, it is possible to prevent the opening/closing member provided on the sheet processing unit used for a job from being opened by mistake because of releasing only the locking mechanism of the opening/closing member in the sheet processing unit in which jamming or an error occurs.

(8) The sheet processing system described in any one of the (1) to (7) above wherein the sheet processing unit is any one of an image forming unit (printer 300), a sheet stacking unit 500, a sheet feeding unit (inserter 600) and a finisher 700.

Further, it is possible to provide a sheet processing system capable of opening/closing part of the opening/closing member even if any job does not end.

Further, it is possible to provide a sheet processing system which limits an opening/closing action of the opening/closing member in the sheet processing unit used for a job and is capable of opening/closing action of the opening/closing member in the sheet processing unit not used for a job.

As described above, the present invention enables to provide a sheet processing system ensuring a high productivity.

This application claims priority from Japanese Patent Application No.2003-356737 filed Oct. 16, 2003, which hereby incorporated by reference herein.

1. A sheet processing system which includes plural sheet processing units each having sheet processing function, and which is capable of executing plural jobs of sheet processing in parallel, each job being actuated by one of the sheet processing units or by a combination of plural sheet processing units, the sheet processing system comprising:
opening/closing members provided on each of the sheet processing units to be accessible to the interior of the sheet processing unit;
sensors which detect the opening/closing state of the opening/closing member; and
a controller which controls a stop of the sheet processing unit according to a signal from the sensor, wherein
the controller carries out stop control for each of the jobs to be executed in parallel according to the result of a detection by the sensor independently.

2. A sheet processing system according to claim 1 wherein
when the sensor detects that any of the opening/closing members is open, the controller executes stop control for one job using a portion accessible through an opening in the opening/closing member and the other job not using a portion accessible through the opening in the opening/closing member independently.

3. A sheet processing system according to claim 1 wherein
when the sensor detects that an opening/closing member provided on a sheet processing unit used for the job is open, the controller stops only the sheet processing unit or the combination of plural sheet processing units used for the job.

4. A sheet processing system according to claim 1 wherein
when it is detected that an opening/closing member provided on a sheet processing unit not used for the job is open, the controller does not stop the sheet processing unit used for the job.

5. A sheet processing system according to claim 1 further comprising notifying means which notifies the opening state of the opening/closing member detected by the sensor, wherein
when the sensor detects that an opening/closing member provided on a sheet processing unit used for the job is open, the controller stops only the sheet processing unit or the combination of plural sheet processing units used for the job and the notifying means notifies that the sheet processing unit is stopped.

6. A sheet processing system according to claim 5 wherein
the notifying means is at least any one of a display unit, a light emission unit and a sound production unit.

7. A sheet processing system according to claim 1 further comprising a locking mechanism which prevents the opening action of the opening/closing member, wherein
the controller controls the locking mechanism so as to prevent an opening/closing member provided on a sheet processing unit used for the job from being opened.

8. A sheet processing system according to claim 7 wherein
when a jamming or error occurs in the sheet processing unit used for the job, the controller releases only the locking mechanisms of the opening/closing member provided on the sheet processing unit or the combination of plural sheet processing units used for the job.

9. A sheet processing system according to any one of claim 1 to 8 wherein
the sheet processing unit is at least any one of an image forming unit, a sheet stacking unit, a sheet feeding unit and a finisher.
